(19) United States
(12) Patent Application Publication
(10) Pub. No.: US 2026/0220820 A1
(43) Pub. Date: Jul. 30, 2026

(54) IMAGE SIGNAL PROCESSING METHOD AND APPARATUS THEREOF

(71) Applicant: TP-Link Systems Inc., IRVINE, CA (US)

(72) Inventor: Wenshi LI, Shenzhen (CN)

(73) Assignee: TP-Link Systems Inc., IRVINE, CA (US)

(21) Appl. No.: 19/038,780

(22) Filed: Jan. 28, 2025

(51) Int. Cl. G06T 9/00; G06T 5/73

(52) U.S. Cl. CPC G06T 9/00; G06T 5/73

(57) ABSTRACT

The disclosure provides an image signal processing method and apparatus thereof. The image signal processing method may include: performing image signal processing on a current image frame in an image stream based on image signal processing (ISP) parameter(s) related to image details; encoding the image signal processed current image frame to generate an encoded current image frame; adaptively adjusting the ISP parameter(s) based on encoding load for the current image frame; performing image signal processing on a subsequent image frame in the image stream based on the adaptively adjusted ISP parameter(s); and encoding the image signal processed subsequent image frame to generate a subsequent encoded image frame.

### TECHNICAL FIELD

The present disclosure relates to the field of image signal processing, and in particular to an image signal processing method and apparatus.

### BACKGROUND

Raw image stream obtained by a camera usually needs to be encoded and compressed before it can be output for presentation. If the quality of the final image presented is positively correlated with the encoding bit rate if other factors affecting image quality are fixed. The higher the encoding bit rate, the better the image quality. However, some image capturing devices or electronic device including the function of image capturing are limited by cost and hardware and have a limited maximum supportable bit rate. Under the limitation of the maximum supportable bit rate, as the details of the captured picture increase, the encoding load increases, since the encoding quality cannot keep up when the encoding load is too heavy, the image is prone to suffer from mosaic phenomenon, which greatly reduces the quality of the final presented image.

Thus, an image processing method and device that improves image quality under the limitation of the fixed maximum encoding bit rate is needed.

### SUMMARY

The present disclosure may provide such an image processing method and apparatus thereof, in which the encoding load is determined in real time and used to adjust image signal processing parameter(s). The image signal processing parameter(s) are then employed to process the image frame before encoding and change the image details in the frame, which finally make an influence on the image quality presented.

According to one aspect of the present disclosure, an image signal processing method comprising: performing image signal processing on a current image frame in an image stream based on image signal processing (ISP) parameter(s) related to image details; encoding the image signal processed current image frame to generate an encoded current image frame; adaptively adjusting the ISP parameter(s) based on encoding load for the current image frame; performing image signal processing on a subsequent image frame in the image stream based on the adaptively adjusted ISP parameter(s); and encoding the image signal processed subsequent image frame to generate a subsequent encoded image frame.

In one embodiment, adaptively adjusting the ISP parameter(s) based on the encoding load comprises: determining whether the encoding load is within a first threshold range; in response to the encoding load being within the first threshold range, making no adjustment to the ISP parameter(s); and in response to the encoding load not being within the first threshold range, adjusting the ISP parameter(s).

In one embodiment, adjusting the ISP parameter(s) includes: in response to the encoding load being above a first threshold, adjusting the ISP parameter(s) so that the image frame processed with the adjusted ISP parameter(s) has less image details than the image frame processed with the ISP parameter(s) before adjustment; and in response to the encoding load being below a second threshold, adjusting the ISP parameter(s) so that the image frame processed with the adjusted ISP parameter(s) has more image details than the image frame processed with the ISP parameter(s) before adjustment.

In one embodiment, the ISP parameter(s) include parameter(s) related to an image sharpening processing.

In one embodiment, adjusting the ISP parameter(s) so that the image frame processed with the adjusted ISP parameter(s) has less image details than the image frame processed with the ISP parameter(s) before adjustment includes adjusting the ISP parameter(s) so that the focus for sharpening the image frame is on low frequencies, and wherein adjusting the ISP parameter(s) so that the image frame processed with the adjusted ISP parameter(s) has more image details than the image frame processed with the ISP parameter(s) before adjustment includes adjusting the ISP parameter(s) so that the focus for sharpening the image frame is on high frequencies.

In one embodiment, the image stream is acquired from a camera.

In one embodiment, whether the encoding load is within the first threshold range is determined based on mosaic noise of the encoded image frame.

In one embodiment, whether the encoding load is within the first threshold range is determined based on the encoding bit rate of the current image frame and the highest encoding bit rate supportable by the camera.

In one embodiment, determining whether the encoding load is within a first threshold range may include: in response to a difference between a current encoding bit rate and a highest encoding bit rate supportable by the camera not being within a third threshold range, determining that the encoding load is within the first threshold range; and in response to the difference between the current encoding bit rate and the highest encoding bit rate supportable by the camera being within a third threshold range and the mosaic noise of the encoded image frame being out of a second threshold range, determining that the encoding load is not within the first threshold range.

In one embodiment, the mosaic noise is determined with a YOLO model.

According to another aspect of the present disclosure, an image signal processing apparatus is provided, comprising: performing image signal processing on a current image frame in an image stream based on image signal processing (ISP) parameter(s) related to image details; encoding the image signal processed current image frame to generate an encoded current image frame; adaptively adjusting the ISP parameter(s) based on encoding load for the current image frame; performing image signal processing on a subsequent image frame in the image stream based on the adaptively adjusted ISP parameter(s); and encoding the image signal processed subsequent image frame to generate a subsequent encoded image frame.

In one embodiment, the operations further comprise: determining whether the encoding load is within a first threshold range; in response to the encoding load being within the first threshold range, making no adjustment to the ISP parameter(s); and in response to the encoding load not being within the first threshold range, adjusting the ISP parameter(s).

In one embodiment, the operations further comprise: in response to the encoding load being above a first threshold, adjusting the ISP parameter(s) so that the image frame processed with the adjusted ISP parameter(s) has less image details than the image frame processed with the ISP parameter(s) before adjustment; and in response to the encoding load being below a second threshold, adjusting the ISP parameter(s) so that the image frame processed with the adjusted ISP parameter(s) has more image details than the image frame processed with the ISP parameter(s) before adjustment.

In one embodiment, the ISP parameter(s) include parameter(s) related to an image sharpening processing.

In one embodiment, the operations further comprise: adjusting the ISP parameter(s) so that the focus for sharpening the image frame is on the low frequencies, and adjusting the ISP parameter(s) so that the focus for sharpening the image frame is on the high frequencies.

In one embodiment, wherein the image stream is acquired from a camera.

In one embodiment, the operations further comprise: determining that the encoding load is within a first threshold range based on mosaic noise of the encoded image frame.

In one embodiment, the operations further comprise: determining that the encoding load is within a first threshold range based on the encoding bit rate of the current image frame and the highest encoding bit rate supportable by the camera.

In one embodiment, the operations further comprise: in response to a difference between a current encoding bit rate and a highest encoding bit rate supportable by the camera not being within a third threshold range, determining that the encoding load is within the first threshold range; and in response to the difference between the current encoding bit rate and the highest encoding bit rate supportable by the camera being within a third threshold range and the mosaic noise of the encoded image frame being out of a second threshold range, determining that the encoding load is not within the first threshold range.

In one embodiment, the mosaic noise is determined with a YOLO model.

The present disclosure determines the encoding state and adaptively adjusts the ISP parameter(s) for different encoding load states to improve the output image quality and achieve an effect equivalent to the general method of increasing the encoding bit rate.

The present disclosure provides an image signal processing method in which, in order to solve the problem of image quality degradation caused by high encoding load, the amount of image information before encoding is directly reduced by means of image signal processing, which in turn reduces encoding load. The quality of the image with even less image details may still be better than the image with a lot of mosaics noises caused by the high encoding load.

Although some details of the picture are abandoned by adjusting the ISP parameter(s), the present disclosure provides the user with a better viewing experience for the processed image stream than the image stream that experiences heavy encoding load.

### BRIEF DESCRIPTION OF DRAWINGS

FIG. 1 illustrates a flowchart of a method for image signal processing according to an embodiment of the present disclosure.

FIG. 2 illustrates a flowchart of a method for adjusting the ISP parameter(s) according to the encoding load according to an embodiment of the present disclosure.

FIG. 3 illustrates comparison between images with and without using the image signal processing method of the present disclosure.

FIG. 4 illustrates an image processing device according to an embodiment of the present disclosure.

FIG. 5 illustrates a flowchart of a method for determining the encoding load according to an embodiment of the present disclosure.

FIG. 6 is a schematic block diagram of an image signal processing apparatus according to an embodiment of the present disclosure.

### DETAILED DESCRIPTION

Before undertaking the DETAILED DESCRIPTION below, it may be advantageous to set forth definitions of certain words and phrases used throughout this patent document. The terms “include” and “comprise”, as well as derivatives thereof, mean inclusion without limitation. The term “or” is inclusive, meaning and/or.

Moreover, various functions described below may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read-Only Memory (ROM), Random Access Memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data may be permanently stored and media where data may be stored and later overwritten, such as a rewritable optical disc or an erasable memory device.

Unless the context clearly indicates otherwise, the singular forms “a”, “an”, “the”, and similar words do not denote a limitation of quantity, but rather denote the presence of at least one.

The various embodiments discussed below to describe the principles of the present disclosure in this patent document are by way of illustration only and should not be construed in any way to limit the scope of the disclosure.

The following description with reference to the accompanying drawings is provided to assist in a comprehensive understanding of various embodiments of the present disclosure as defined by the claims and their equivalents. This description includes various specific details to assist in that understanding but are to be regarded as merely exemplary. Accordingly, those of ordinary skill in the art will recognize that various changes and modifications may be made to the various embodiments described herein without departing from the scope and spirit of the present disclosure. In addition, descriptions of well-known functions and constructions may be omitted for clarity and conciseness.

Unless defined differently, all terms (including technical terms or scientific terms) used in this disclosure have the same meaning as understood by those skilled in the art to which this disclosure belongs. Common terms as defined in dictionaries are interpreted to have meanings consistent with the context in the relevant technical field, and should not be interpreted ideally or overly formally unless expressly so defined in this disclosure.

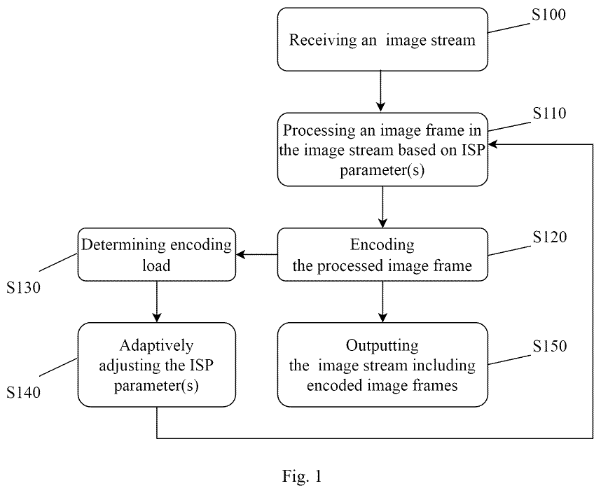

FIG. 1 through FIG. 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Encoding load usually refers to the computing resources and processing power required when encoding data (such as video or audio encoding). When the encoding load is too high, the mosaic noise generated in the picture will destroy the contours and details of the objects in the picture at the same time, giving people the feeling that the image quality is greatly reduced. There are many ways to improve the image quality degradation caused by encoding load. The common method is to improve the encoding algorithm or increase the bit rate. These common methods may lead to higher hardware requirements and ultimately increase costs. Especially under the condition of limited small electronic devices, the above improvement method may not be applicable.

In image signal processing, high-frequency information of the image mainly corresponds to image details, while low-frequency information mainly corresponds to the overall shape and content of the image, such as contours in the image, flat areas in the image, background information and changes in color and brightness (excluding subtle variations in detail). The image details may include information related to the edge and outline of the object, image texture, random noises, small features in the image and so on.

Generally, human eye subjectively pays attention to the overall shape and content of the picture first, and then to the details of the picture. Therefore, for the same picture, retaining the contours will subjectively give people a clearer feeling than retaining the details. In view of the above situation, for scenarios with complex picture content, the amount of picture information may be reduced by reducing the picture details, so as to avoid the mosaic noise caused by excessive encoding load, and at the same time, people's feeling of loss in image details may be reduced by retaining the contours of the object in the picture.

Based on this concept, the present disclosure provides an image signal processing method and apparatus thereof, which may directly reduce the amount of image information before encoding to address the problem of image quality degradation caused by excessive encoding load. Encoding images with reduced information may reduce the encoding load that the device needs to cope with. Furthermore, whether to reduce the amount of image information before encoding may be determined based on the encoding load determined in real time by an Artificial Intelligent method. One example method for reducing the amount of image information before encoding is by adjusting image signal processing (ISP) parameter(s) which is then used to process the image before encoding. And the image signal processing (ISP) parameter(s) may include parameter(s) related to sharpening processing. It may be seen from the experimental results (as shown in FIG. 3 below) that a normally encoded image with a low amount of information may have higher quality than an image with mosaic noise under heavy encoding load.

FIG. 1 illustrates an image signal processing method according to an embodiment of the present disclosure.

As shown in FIG. 1, the image signal processing method according to the present disclosure may include receiving an image stream in step S100 and performing image signal processing on a current image frame in an image stream including a plurality of image frames based on image signal processing (ISP) parameter(s) in step S110. The image stream may be received from an image capturing device (such as a camera, which may be a surveillance camera specifically) or an electronic device including the function of image capturing. As mentioned previously, the device may be limited in aspects of cost and hardware, and each device may have the highest encoding bit rate it may support.

In one example, the ISP parameter(s) may be parameter(s) related to image details, this is, when the ISP parameter(s) are used in the image signal processing, the image details of the processed image frame may be changed. The ISP parameter(s) initially used may be default ISP parameter(s).

In one detailed example, the ISP parameter(s) may include parameter(s) related to sharpening the image frame, and in this case, the original ISP parameter(s) may perform predetermined sharpening processing on the image frame.

Performing image signal processing on the received image stream actually refers to performing image signal processing on a plurality of image frames included in the obtained image stream. Therefore, the results in step S110 includes the image signal processed image frame after image signal processing using the current ISP parameter(s).

In step S120, the current image frame after image signal processing is encoded to generate an encoded image frame. Then the flow goes to both step S130 and S150.

In step S150, an encoded image stream including the encoded image frames may be output for view by the user.

In step S130, the encoding load for encoding the current image frame is determined, and the encoding load is associated with the load caused by encoding the current image frame. Then the flow goes to step S140.

When the encoding load is too high for the current device, the encoded image could show poor quality (for example, with a lot of mosaic noise). However, if the encoding load is too low, for example, the encoding bit rate is much smaller than the highest supportable bitrate, the image quality would also be poor. Therefore, the mosaic noise and current bit rate could be used to determine the encoding load. Other metrics that could measure the image quality or other way to reflect the encoding load is possible too.

In step S140, the ISP parameter(s) may be adaptively adjusted based on the determined encoding load. The phrase “adaptively adjust(ed)” here means the ISP parameter(s) may eight be adjusted or not be adjusted depending on the determined encoding load.

In an embodiment, adaptively adjusting the ISP parameter(s) may include: adjusting the ISP parameter(s) so that the image frame after processing by the ISP parameter(s) has more details of the image when the encoding load is too heavy (e.g., higher than the first threshold); adjusting the ISP parameter(s) so that the image frame after processing by the ISP parameter(s) has more details of the image when the encoding load is too light (e.g., lower than the second threshold); and maintaining the ISP parameter(s) when the encoding load is suitable.

In one embodiment, whether the encoding load is light or heavy may be measured by determining whether the encoding load is within a pre-determined range. And whether the encoding load is light or heavy may be measured by examining the image quality of the encoded image frame or by checking the current encoding bit rate. In the case of heavy encoding load, the ISP parameter(s) may be adjusted to abandon part of the picture details of the image frame, which in turn decrease the encoding load and improve the output image quality; while in the case of light encoding load, the ISP parameter(s) may be adjusted to enhance part of the picture details of the image frame, which in turn increase the encoding load and also improve the output image quality by means of enhancement of the image details. Therefore, the user experience is improved.

In an embodiment, the ISP parameter(s) may include parameter(s) related to image sharpening processing. If the encoding load is too heavy (e.g., higher than the first threshold), ISP parameter(s) may be adjusted so that the sharpening focus is on the low frequency. In this way, focus will be on the contours of the picture content and some picture details are abandoned and thus the encoding load is alleviated. If the encoding load is too light (e.g., lower than the second threshold), the ISP parameter(s) may be adjusted so that the sharpening focus is on the high frequency, which results in more picture details being obtained.

It should be noted that after some adjustment of the ISP parameter(s) due to the heavy encoding load, if the encoding load for the subsequent image frame is lower than the second threshold, that is, when there are surplus computing resources and processing power, adjusting the ISP parameter(s) includes restoring the ISP parameter(s) in the direction of the initial ISP parameter(s). For example, the ISP parameter(s) may be adjusted so that the sharpening focus is adjusted back to high frequency.

After the ISP parameter(s) are adaptively adjusted, the followed image frame may be processed using the adjusted ISP parameters, and thus the encoded image stream in step S150 may not only include the encoded image frame(s) that are processed with the initial ISP parameter(s), and but also the encoded image frame(s) that are processed with the adjusted ISP parameter(s).

As shown in FIG. 1, all the image frame included in the received image stream may be processed using the ISP parameter(s), encoded and output at last. Different image frame might be processed using different ISP parameter(s), since the ISP parameter(s) are adaptively adjusted based on the encoding load for the previous image frame.

That is, in the image signal processing method according to the present disclosure, the real-time encoding load is monitored, and in the case of heavy encoding load, part of the picture details of the image frame are abandoned by adjusting the ISP parameter(s) to achieve better image quality under the limitation of the hardware and software of the device.

When the encoding load is too heavy for the device, the image quality might be poor, for example, showing a lot of mosaics noises, adjusting the ISP parameter(s) so as to giving up some image details could alleviate the encoding load, and by controlling the adjustment of the ISP parameter(s), the quality of the image with even less image details may still be better than the image with a lot of mosaics noises.

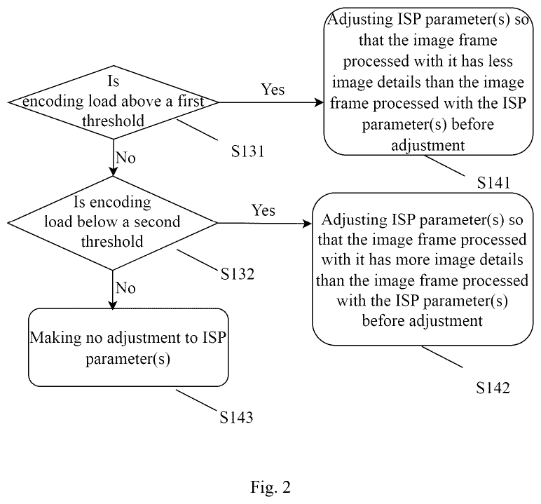

FIG. 2 provides an example method for adjusting the ISP parameter(s) based on the encoding load.

The determination of the encoding load in step S130 of FIG. 1 according to the method of the present disclosure may include determining whether the encoding load is within a threshold range (e.g., a first threshold range).

When the encoding load is within a threshold range, the encoding load is within the acceptable range of the device, and no adjustment should be made to the current ISP parameter(s). Then the image frames in the image stream may be continued to be encoded with the current ISP parameter(s) and the encoded image stream including the encoded image frames may be output for display. In this case, even without any adjustment to the ISP parameter(s), no mosaic noise would occur under a relatively high bitrate. When the encoding load is not within a threshold range, the ISP parameter(s) adjusted.

In step S131, whether the determined encoding load due to encoding the current image frame is above a first threshold is determined. If yes, the flow goes to step S141; otherwise, the flow goes to step S132.

In step S141, the ISP parameter(s) is adjusted so that the image processed with it has more image details than the image processed with the ISP parameter(s) before adjustment. In one example, the ISP parameter(s) is adjusted in step S141 so that it is closer to the original ISP parameter(s).

In step S132, whether the determined encoding load due to encoding the current image frame is below a first threshold is determined. If yes, the flow goes to step S142; otherwise, the flow goes to step S143.

In step S142, the ISP parameter(s) is adjusted so that the image processed with it has less image details than the image processed with the ISP parameter(s) before adjustment. In one example, the ISP parameter(s) is adjusted so that it is closer to the original ISP parameter(s). In one example, the ISP parameter(s) is adjusted in step S142 so that it is further to the original ISP parameter(s). In step S143, no adjustment may be made to the ISP parameter(s), since according to the above steps, the encoding load is determined to be within a range from the second threshold to the first threshold.

In one example, adjusting the ISP parameter(s) so that the image frame processed with the adjusted ISP parameter(s) has less image details than the image frame processed with the ISP parameter(s) before adjustment includes adjusting the ISP parameter(s) so that the focus for sharpening the image frame is on low frequencies, and adjusting the ISP parameter(s) so that the image frame processed with the adjusted ISP parameter(s) has more image details than the image frame processed with the ISP parameter(s) before adjustment includes adjusting the ISP parameter(s) so that the focus for sharpening the image frame is on high frequencies.

In a particular embodiment, specific ISP parameter(s) may be adjusted by invoking an ISP interface. The ISP interface here refers to an interface with at least one ISP parameter from outside, which may be used for later external calls and adjustments. The ISP interface is remained as a way to change the ISP parameter(s) when packaging equipment and programs together rather than setting all the ISP parameter(s) steady.

In an embodiment, after some adjustment of the ISP parameter(s) due to the encoding load being higher than the first threshold, if the encoding load for a subsequent image frame is lower than the second threshold, adjusting the ISP parameter(s) may include gradually adjusting the ISP parameter(s) back to the original ISP parameter(s).

FIG. 2 shows an example to correlate the encoding load with the ISP parameter(s). By this example, the ISP parameter(s) may be adaptively adjusted according to the encoding load. If the encoding load is above the first threshold, the ISP parameter(s) may be adjusted so that the image frame processed with the adjusted ISP parameter(s) has more image details than the image frame processed with the ISP parameter(s) before adjustment; if the encoding load is below the second threshold, the ISP parameter(s) may be adjusted to increase the details of the image frame; and if the encoding load is a load between the second threshold and the first threshold, then nothing may be done to the ISP parameters. Thus, the changing ISP parameters could reflect the encoding load for the last image frame and alleviate the encoding load for the subsequent image frame or utilize more resources or processing power for the subsequent frames.

FIG. 3 illustrates comparison between images with and without using the image signal processing method of the present disclosure. FIG. 3(a) is an image without implementing the image signal processing method of the present disclosure, and FIG. 3(b) is an image with using the image signal processing method of the present disclosure. It may be seen that in FIG. 3(a), there is a lot of mosaic noise in the picture and the image quality is poor. In FIG. 3(b), the ISP interface is called to adjust the ISP parameter(s) related to image frame sharpening which leads to improving quality of the image after encoding, and thereby transmitting a clearer image to the viewer.

This is, although some details of the picture are abandoned by adjusting the ISP parameter(s) and using the adjusting ISP parameter to process the image frame, the present disclosure provides the user with a better viewing experience for the processed image stream than the image stream that suffers from larger mosaic noise due to greater encoding load.

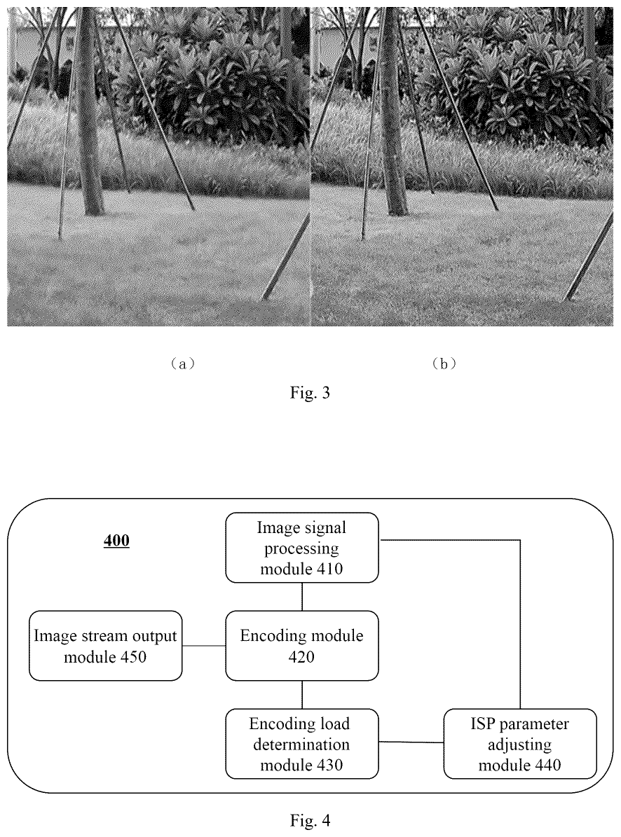

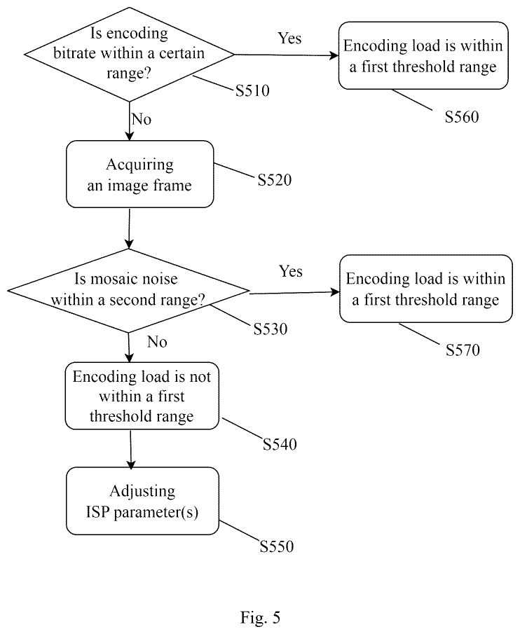

FIG. 4 illustrates an image signal processing apparatus 400 according to an embodiment of the present disclosure.

The image signal processing apparatus 400 may include an image signal processing module 410; an encoding module 420; an encoding load determination module 430; ISP parameter adjusting module 440; and an image stream output module 450. Among them, the image signal processing module 410 may be connected to the encoding module 420, and the encoding module may be connected to the encoding load determination module 430 and the image stream output module 450 respectively; the encoding load determination module 430 may also be connected to the ISP parameter adjusting module 440; and the ISP parameter adjusting module 440 may be connected to the image signal processing module 410.

The image signal processing module 410 may be configured to perform image signal processing on a received image stream, the image stream including a plurality of image frames, based on image signal processing (ISP) parameter(s) related to image details.

The encoding module 420 may be configured to encode the image signal processed image frame to generate an encoded image frame.

The encoding load determination module 430 may be configured to determine the encoding load when encoding the current image frame, the encoding load being associated with the load caused by encoding the current image frame.

The ISP parameter adjusting module 440 may be configured to adaptively adjust the ISP parameter(s) based on the encoding load.

The image signal processing module 410 may be further configured to perform image signal processing on subsequent image frames in the image stream based on the adaptively adjusted ISP parameter(s) to obtain subsequent image frames after image signal processing.

The encoding module 420 may be further configured to encode subsequent image frames of the image signal processing to generate encoded image frames.

The image stream output module 450 may include an image output interface and may be configured to output an encoded image stream including encoded image frames.

Encoding load according to embodiments of the present disclosure may be determined by referring to the parameter(s) that evaluate image quality and the encoding bitrate. More specifically, the encoding load may be determined based on the mosaic noise of the encoded image frame and/or the current encoding bit rate.

According to an embodiment of the present disclosure, the encoding load determination module 430 may determine the current encoding load based on at least one of the current encoding code rate and mosaic noise of the encoded image frame.

FIG. 5 illustrates a flowchart of a method of determining the encoding load according to an embodiment of the present disclosure. This method may be performed by the encoding load determination module 430 in the image signal processing apparatus 400 as described above.

In step S510, it is determined whether the encoding bit rate obtained in real time is within a certain range (for example, a third threshold range). The encoding bit rate is for the image frame in the image stream obtained from a camera. In one example, determining whether the encoding bit rate obtained in real time is within a certain range may include determining whether the difference between the current encoding bit rate and the highest encoding bit rate that the camera may support is within another threshold range (e.g., a third threshold range).

If the encoding bit rate obtained in real time is not within the certain rang (for example, the third threshold range)e, the flow goes to step S520; otherwise, the flow goes to step S560. In step S560, it is determined that the encoding load is within the first threshold range, in which case the ISP parameter(s) are maintained, and will not be adjusted.

However, in step S520, image frame acquisition is performed. The procedure goes to step S530 then.

In step S530, mosaic noise in the acquired image frame is identified through AI method (for example, using the YOLO model, which will be described in detail below), and it is determined that whether the mosaic noise is within a second threshold range. If yes, the procedure goes to step S570; otherwise, the procedure goes to step S540.

In step S540, in response to the mosaic noise in the image frame is not within the second threshold range, it is determined that the encoding load is not within the first threshold range and the procedure goes to step S550. In Step S550, the ISP parameter(s) may be adjusted. The adjustment may be done as shown in FIG. 2, so detailed descriptions are omitted. In a specific example, in response to the mosaic noise in the image frame is above a third threshold, it is determined that the encoding load is above the first threshold, and the ISP parameter(s) is adjusted so that the image frame processed with the adjusted ISP parameter(s) has less image details than the image frame processed with the ISP parameter(s) before adjustment; and in response to the mosaic noise in the image frame is below a fourth threshold, it is determined that the encoding load is below the second threshold, and the ISP parameter(s) is adjusted so that the image frame processed with the adjusted ISP parameter(s) has more image details than the image frame processed with the ISP parameter(s) before adjustment.

In step S570, in response to the mosaic noise in the image frame is within the second threshold range, it is determined that the encoding load is within the first threshold range, in which case the ISP parameter(s) are maintained, and will not be adjusted.

As an example, a YOLO model may be used to determine (for example, predict) the mosaic noise. The YOLO model is an object recognition and localization algorithm based on deep neural networks. It is characterized by its fast running speed and is suitable for real-time systems. This module is often used for object detection, but in the embodiment of the present disclosure, the YOLO model is used to determine the mosaic noise, that is, mosaic noise is used as its detection target.

If the YOLO model is reduced to multiple grids, then each grid is responsible for detecting internal objects, and each grid predicts the presence or absence of mosaic areas (objects) within the grid rather than specific pixel values. The YOLO model may extract image features by convolving the features of each grid, and then determine whether the noises have mosaic properties (such as blocking effects, etc.). If the noises have mosaic properties, it is determined that there is a mosaic area. When using the YOLO model to determine whether there is a mosaic area, the size of the mosaic noise may be determined by the size of the identified mosaic area. For example, when the number of recognized mosaic areas exceeds the fourth threshold range, the size of the mosaic noise is considered to exceed the second threshold range, otherwise, the size of the mosaic noise is considered to be within the second threshold range.

Other embodiments of determining the encoding load are also possible. For example, in one embodiment, determining the encoding load may include: in response to mosaic noise of the encoded image frame being within a second threshold range, determining that the encoding load is within a first threshold range; in response to the mosaic noise of the encoded image frame not being within a second threshold range, determining that the encoding load is not within the first threshold range.

In another embodiment, determining the current encoding load includes: in response to the difference between the current encoding bit rate and the highest encoding bit rate that the camera may support being within a third threshold range, or the current encoding bit rate is close to the highest encoding bit rate, determining that the encoding load is not within the first threshold range, that is, the encoding load might be too high; in response to the difference between the current encoding bit rate and the highest encoding bit rate that the camera may support is not within the third threshold range, or the current encoding bit rate is far away from the highest encoding bit rate, it is determined that the encoding load is within the first threshold range, that is, the encoding load might be acceptable.

In yet another embodiment, determining the current encoding load includes: in response to the difference between the current encoding bit rate and the highest encoding bit rate that may be supported by the camera being within a third threshold range (that is, the encoding bit rate is close to the highest encoding bit rate) and the mosaic noise of the encoded image frame is not within the second threshold range (i.e., the mosaic noise is large), determining that the encoding load is not within the first threshold range, that is, the encoding load might be too high; in response to the difference between the current encoding code rate and the highest encoding code rate that the camera may support is not within the third threshold range (i.e., the encoding code rate is far from the highest encoding bit rate) and the mosaic noise of the encoded image frame is within the second threshold range (that is, the mosaic noise is small), it is determined that the encoding load is within the first threshold range, that is, the encoding load might be acceptable.

According to the one or more embodiments above, the encoding load could be determined by observable parameters like encoding bitrate, thereby providing a possible solution for determination of the encoding load. Besides, the disclosure provides a quantifiable and artificial intelligent approach for detection of the mosaic noises, which is then used as a quick and accurate evaluation for the image quality caused by the heavy encoding load. By considering both the encoding bitrate and the mosaic noises, the encoding load could be reflected in a better way, and act as an indicator to adjust the ISP parameter(s), which are fed back to the process before encoding and finally solves the problems caused by too-heavy encoding bitrate.

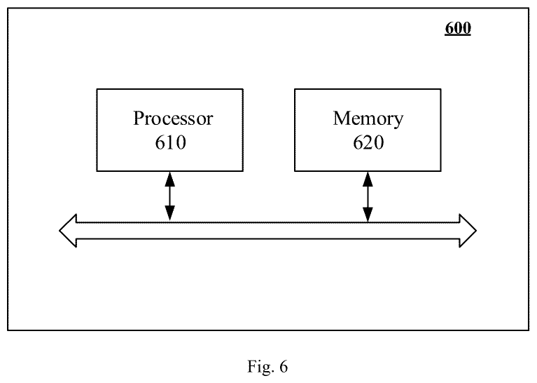

FIG. 6 is a schematic block diagram of an image signal processing apparatus according to an embodiment of the present disclosure. It should be noted that the image signal processing apparatus depicted in FIG. 6 may correspond to the image signal processing apparatus 400 in FIG. 4 as described above and may be used to perform the methods for image signal processing of the image signal processing apparatus as described in the above with respect to any of the methods depicted in FIG. 1, FIG. 2, and FIG. 5.

As shown in FIG. 6, the image signal processing apparatus 600 may comprise a processor 610 and a memory(s) 620. The processor 610 may be one or more processors and may perform the functions of at least one of the modules as shown in the FIG. 4, and the processor(s) 610 is communicatively coupled with the memory 620 via a communication bus. The memory 620 may be one or more memories and have computer-executable instructions therein which, when executed by the processor(s) 610, cause the processor(s) 610 to perform any of the methods depicted in FIG. 1, FIG. 2, and FIG. 5 as described above.

Examples of processor(s) 610 comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor(s) 610 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on memory 620.

The memory(s) 620 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. Memory 620 may reside in processor(s) 610, external to processor(s) 610, or distributed across multiple entities including processor(s) 610. The memory(s) 620 may be embodied in a computer program product.

In addition, according to another embodiment of the present disclosure, a computer program product for image signal processing is disclosed. As an example, the computer program product comprises a non-transitory computer readable storage medium having program instructions embodied therewith, and the program instructions are executable by a processor. When executed, the program instructions cause the processor to perform one or more of the procedures above described, and details are omitted herein for conciseness. By way of example, a computer program product may include a computer-readable medium in packaging materials. Those skilled in the art will recognize how to implement the described functionality presented throughout this disclosure depending on the particular application and the overall design constraints imposed on the overall system.

The present disclosure describes an image signal processing method that improves image quality degradation caused by encoding. This method adjusts the image stream before encoding by image signal processing, reduces the amount of original data, and finally reduces the mosaic noise in the process of encoding and compression, and improves the image quality.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

An expression such as “according to,” “based on,” “depend on,” and so on as used in the disclosure does not mean “according only to,” “based only on,” or “dependent only on,” unless it is explicitly otherwise stated. In other words, such expression generally means “according at least to,” “based at least on,” or “depend at least on” in the disclosure.

The term “determining” used in the disclosure may include various operations. For example, regarding “determining,” calculating, computing, processing, deriving, investigating, looking up (e.g., looking up in tables, databases, or other data structure), ascertaining, and so forth are regarded as “determination”. In addition, regarding “determining,” receiving (for example, receiving information), transmitting (for example, transmitting information), input, output, accessing (for example, access to data in the memory), and so forth, are also regarded as “determining”. In addition, regarding “determining,” resolving, selecting, choosing, establishing, comparing, and so forth may also be regarded as “determining.” That is, regarding “determining,” several actions may be regarded as “determining.”

It should be noted that the above description is only some embodiments of the present disclosure and an illustration of the applied technical principles. It should be understood by those skilled in the art that the present disclosure scope involved in the present disclosure is not limited to the technical solutions resulting from specific combinations of the above technical features, but also encompasses other technical solutions resulting from any combination of the above technical features or their equivalents without departing from the above disclosed concept, for example, the technical solutions formed by replacing between the above features and the technical features with similar functions disclosed in the present disclosure (but not limited hereto).

The present disclosure has been described in detail above, but it is obvious to those skilled in the art that the present disclosure is not limited to the embodiments described in the disclosure. The present disclosure may be implemented as a modified and changed form without departing from the spirit and scope of the present disclosure defined by the description of the claims. Therefore, the description in the disclosure is for illustration and does not have any limiting meaning to the present disclosure.

What is claimed is:

1. An image signal processing method, comprising:
performing image signal processing on a current image frame in an image stream based on image signal processing (ISP) parameter(s) related to image details;
encoding the image signal processed current image frame to generate an encoded current image frame;
adaptively adjusting the ISP parameter(s) based on encoding load for the current image frame;
performing image signal processing on a subsequent image frame in the image stream based on the adaptively adjusted ISP parameter(s); and
encoding the image signal processed subsequent image frame to generate a subsequent encoded image frame.

2. The method of claim 1, wherein adaptively adjusting the ISP parameter(s) based on the encoding load comprises:
determining whether the encoding load is within a first threshold range;
in response to the encoding load being within the first threshold range, making no adjustment to the ISP parameter(s); and
in response to the encoding load not being within the first threshold range, adjusting the ISP parameter(s).

3. The method of claim 2, wherein adjusting the ISP parameter(s) includes:
in response to the encoding load being above a first threshold, adjusting the ISP parameter(s) so that the image frame processed with the adjusted ISP parameter(s) has less image details than the image frame processed with the ISP parameter(s) before adjustment; and
in response to the encoding load being below a second threshold, adjusting the ISP parameter(s) so that the image frame processed with the adjusted ISP parameter(s) has more image details than the image frame processed with the ISP parameter(s) before adjustment.

4. The method of claim 3, wherein the ISP parameter(s) include parameter(s) related to an image sharpening processing.

5. The method of claim 4, wherein adjusting the ISP parameter(s) so that the image frame processed with the adjusted ISP parameter(s) has less image details than the image frame processed with the ISP parameter(s) before adjustment includes adjusting the ISP parameter(s) so that the focus for sharpening the image frame is on low frequencies, and
wherein adjusting the ISP parameter(s) so that the image frame processed with the adjusted ISP parameter(s) has more image details than the image frame processed with the ISP parameter(s) before adjustment so that the focus for sharpening the image frame is on high frequencies.

6. The method of claim 5, wherein the image stream is acquired from a camera, and
the method further includes outputting an encoded image stream including all the encoded image frames.

7. The method of claim 2, wherein whether the encoding load is within the first threshold range is determined based on mosaic noise of the encoded image frame.

8. The method of claim 2, wherein whether the encoding load is within the first threshold range is determined based on the encoding bit rate of the current image frame and the highest encoding bit rate supportable by the camera.

9. The method of claim 2, wherein determining whether the encoding load is within the first threshold range comprises:
in response to a difference between a current encoding bit rate and a highest encoding bit rate supportable by the camera not being within a third threshold range, determining that the encoding load is within the first threshold range; and
in response to the difference between the current encoding bit rate and the highest encoding bit rate supportable by the camera being within a third threshold range and the mosaic noise of the encoded image frame being out of a second threshold range, determining that the encoding load is not within the first threshold range.

10. The method of claim 7, wherein the mosaic noise is determined with a YOLO model.

11. An image signal processing apparatus, comprising:
a processor; and
a memory having stored thereon computer program which, when executed by the processor, causes the processor to perform operations comprising:
performing image signal processing on a current image frame in an image stream based on image signal processing (ISP) parameter(s) related to image details;
encoding the image signal processed current image frame to generate an encoded current image frame;
adaptively adjusting the ISP parameter(s) based on encoding load for the current image frame;
performing image signal processing on a subsequent image frame in the image stream based on the adaptively adjusted ISP parameter(s); and
encoding the image signal processed subsequent image frame to generate a subsequent encoded image frame.

12. The apparatus of claim 11, wherein the operations further comprise:
determining whether the encoding load is within a first threshold range;
in response to the encoding load being within the first threshold range, making no adjustment to the ISP parameter(s); and
in response to the encoding load not being within the first threshold range, adjusting the ISP parameter(s).

13. The apparatus of claim 12, wherein the operations further comprise:
in response to the encoding load being above a first threshold, adjusting the ISP parameter(s) so that the image frame processed with the adjusted ISP parameter(s) has less image details than the image frame processed with the ISP parameter(s) before adjustment; and
in response to the encoding load being below a second threshold, adjusting the ISP parameter(s) so that the image frame processed with the adjusted ISP parameter(s) has more image details than the image frame processed with the ISP parameter(s) before adjustment.

14. The apparatus of claim 13, wherein the ISP parameter(s) include parameter(s) related to an image sharpening processing.

15. The apparatus of claim 14, wherein the operations further comprise: adjusting the ISP parameter(s) so that the focus for sharpening the image frame is on low frequencies, and adjusting the ISP parameter(s) so that the focus for sharpening the image frame is on high frequencies.

16. The apparatus of claim 15, wherein the image stream is acquired from a camera and
wherein, the operations further comprise outputting an encoded image stream including all the encoded image frames.

17. The apparatus of claim 2, wherein the operations further comprise: determining whether the encoding load is within a first threshold range based on mosaic noise of the encoded image frame.

18. The apparatus of claim 12, wherein the operations further comprise: determining whether the encoding load is within a first threshold range based on the encoding bit rate of the current image frame and the highest encoding bit rate supportable by the camera.

19. The apparatus of claim 12, wherein the operations further comprise:
in response to a difference between a current encoding bit rate and a highest encoding bit rate supportable by the camera not being within a third threshold range, determining that the encoding load is within the first threshold range; and
in response to the difference between the current encoding bit rate and the highest encoding bit rate supportable by the camera being within a third threshold range and the mosaic noise of the encoded image frame being out of a second threshold range, determining that the encoding load is not within the first threshold range; and
wherein the mosaic noise is determined with a YOLO model.

20. A computer program product comprising a computer readable storage medium having computer-executable instructions therein which, when executed by a processor, cause the processor to perform the method of claim 1.
